(19) United States
(12) Patent Application Publication
(10) Pub. No.: US 2023/0017980 A1
(43) Pub. Date: Jan. 19, 2023

(54) SLIDER DEVICE AND HANDRAIL APPARATUS

(71) Applicant: Tatsuo ONO, Tokyo (JP)

(72) Inventor: Tatsuo ONO, Tokyo (JP)

(21) Appl. No.: 17/782,890

(22) PCT Filed: Jan. 26, 2021
(86) PCT No.: PCT/JP2021/002572

§ 371 Date: Jun. 6, 2022

(30) Foreign Application Priority Data
Mar. 6, 2020 (JP) 2020-038586

(51) Int. Cl. E04G 21/32; A62B 35/00

(52) U.S. Cl. CPC E04G 21/3242; E04G 21/3295; A62B 35/0087

(57) ABSTRACT

There is provided a slider device that includes: a slider main body that can move in the extending direction of a handrail while holding the handrail; and a plurality of pairs of rollers that are provided on the slider main body in a plurality of places apart from each other in the extending direction of the handrail, grasp side surfaces of the handrail, and can travel on the side surfaces of the handrail. One of the rollers facing each other across the handrail is a fixed roller fixed to the slider main body and the other of the rollers facing each other across the handrail is a movable roller supported in such a manner as to be able to get farther or closer with respect to the handrail, and each movable roller is biased toward the handrail by a biasing member.

### TECHNICAL FIELD

This invention relates to a slider device and a handrail apparatus.

### BACKGROUND ART

In general, in the erection site of an erection such as a multistoried building or the construction site of a bridge or the like, a handrail apparatus for protecting the safety of a worker is provided at an end of a floor, a beam, a passage, or the like (hereinafter, referred to as a “passage or the like”) for the worker to perform work on or pass through or near the end.

Examples of the handrail apparatus include, as disclosed in JP 2016-44525 A, an apparatus including: a plurality of vertical props arranged in the lateral direction along an end of a passage or the like; a handrail stretched between adjacent vertical props; and a slider device that is mounted on the handrail in a freely movable manner and can hold a lifeline.

The slider device has: a slider main body to which one end of a lifeline can be coupled and that is mounted in such a manner as to be movable along the handrail; and rollers that are provided on an upper portion and side portions of the slider main body and can travel on the upper surface and the side surfaces of the handrail, respectively.

Thereby, the worker can move on the passage or the like in a state where a lifeline is coupled to the handrail apparatus.

### CITATION LIST

### Patent Literature

Patent Literature 1: JP 2016-44525 A

### SUMMARY OF INVENTION

### Technical Problem

However, when the handrail is curved or when an obstacle, such as a handrail holding member for coupling the handrail to the vertical prop or a handrail coupling member coupling handrails, is present partway in the handrail, the conventional slider device has been unable to pass through the portion.

Thus, an object of the present invention is to provide a slider device that can pass even through a curved portion of a handrail or a portion with an obstacle, and a handrail apparatus including the slider device.

### Solution to Problem

In order to achieve the above object, a slider device of the present invention includes: a slider main body that is mounted in such a manner as to be freely movable along the extending direction of a handrail, can hold a lifeline, and can move in the extending direction of the handrail while holding the handrail; and a plurality of pairs of rollers that are provided on the slider main body in a plurality of places apart from each other in the extending direction of the handrail, grasp side surfaces of the handrail, and can travel on the side surfaces of the handrail; in the slider device, one of the rollers facing each other across the handrail is a fixed roller fixed to the slider main body and the other of the rollers facing each other across the handrail is a movable roller supported in such a manner as to be able to get farther or closer with respect to the handrail, and each of the movable rollers is biased toward the handrail by a biasing member. In the case of this configuration, the movable roller is supported on the slider main body in such a manner as to be able to get farther or closer with respect to the handrail, and is biased toward the handrail by a coil spring; therefore, when the slider device passes through a portion that hinders smooth traveling, such as a curved portion or an uneven portion of the handrail, the movable roller gets farther or closer according to the shape of the portion that hinders smooth traveling.

The handrail apparatus may include: a plurality of vertical props attached to an attachment target member and standing; a handrail holding member provided on each of the vertical props; a handrail held by the handrail holding members and stretched between adjacent ones of the vertical props; and the slider device mounted in such a manner as to be freely movable along the extending direction of the handrail. In this configuration, since the slider device can pass even through the shape of a portion that hinders smooth traveling, the worker can smoothly move on the passage or the like in a state where a lifeline is attached to the slider device.

The handrail holding member may have: a socket that is coupled to the vertical prop and into which the handrail can be inserted; a wedge that is inserted into the socket and can grasp the handrail together with the socket; and a retaining mechanism coupling the wedge to the socket in a freely slidable manner and pressing the wedge against the socket; the retaining mechanism may have: a long hole formed in the wedge along the insertion direction of the wedge; a bolt shaft protruding inward from the socket and inserted into the long hole; a coil spring mounted on the outer periphery of the bolt shaft; and a nut screwed to an end portion of the bolt shaft and applying a compressive load to the coil spring. In the case of this configuration, since the wedge is constantly pressed against the socket by the coil spring, the wedge can be prevented from coming off after the wedge is inserted between the socket and the handrail to couple the handrail to the vertical prop.

A spacer in a cylindrical shape that is mounted on the outer periphery of the bolt shaft and regulates the movement in the tightening direction of the nut may be provided. In the case of this configuration, since the tightening amount of the nut can be constantly fixed, a variation in the biasing force of the coil spring can be prevented.

The handrail may have: a plurality of bar members held by the handrail holding members and each provided with insertion holes in both end portions; and a handrail coupling member coupling end portions facing each other of adjacent ones of the bar members; the handrail coupling member may have: a cylindrical body into which the bar member can be inserted; a pair of opening holes provided in the cylindrical body along the axial direction; stop pins inserted into the opening holes in such a manner as to freely exit or enter; and spring members biasing the stop pins in the insertion directions, and may couple end portions of adjacent ones of the bar members by a process in which the end portions of the adjacent bar members are inserted into the cylindrical body from both sides and the stop pins are inserted into the insertion holes of the bar members and the opening holes of the cylindrical body in a state where the insertion holes and the opening holes are made to face each other. In the case of this configuration, end portions of adjacent bar members can be easily coupled by simply inserting the bar members into the cylindrical body and inserting the stop pins into the insertion holes of the bar members and the opening holes of the cylindrical body in a state where the insertion holes and the opening holes are made to face each other; therefore, the assembly work of the handrail apparatus is easy, and workability is improved.

The handrail apparatus of the present invention may have a fixing tool that fixes the vertical prop to the attachment target member; the fixing tool may have: a main body portion that has a support piece and a fixed grasping piece arranged facing each other with a predetermined gap and a coupling piece coupling one end of the support piece and one end of the fixed grasping piece and to which the vertical prop is fixed; a movable grasping piece that is placed between the support piece and the fixed grasping piece and can grasp the attachment target member together with the fixed grasping piece; and an operating unit that has an outer cylinder fixed to the support piece and a movable shaft that is inserted into the outer cylinder in such a manner as to be movable in the axial direction while being blocked from rotation against the outer cylinder and to the terminal end of which the movable grasping piece is coupled, and that causes the movable shaft to exit or enter the outer cylinder to move the movable grasping piece farther or closer with respect to the fixed grasping piece; the movable grasping piece may have: a flat plate portion in a single plate shape joined to the terminal end of the movable shaft; and bent portions formed by bending a pair of side end portions of the flat plate portion facing each other in the extending direction of the handrail toward the fixed grasping piece. In the case of this configuration, a size increase of the fixing tool can be prevented while an increase in the inclination of the vertical prop is prevented, and the fixing tool can be prevented from slipping off from the attachment target member.

### Advantageous Effects of Invention

In the case of the slider device and the handrail apparatus of the present invention, passage is possible even through a portion that hinders smooth traveling, such as a curved portion or an uneven portion of the handrail, and therefore the worker can smoothly move on the passage or the like; thus, working efficiency is improved. Furthermore, since each movable roller is biased toward the handrail by a biasing member, rattling can be prevented when the slider device moves on the handrail.

### BRIEF DESCRIPTION OF DRAWINGS

FIG. 1 is an overall perspective view showing a state where a handrail apparatus of the present embodiment is used.

FIG. 2 is a side view of a prop apparatus in the handrail apparatus of the present embodiment.

FIG. 3 is a front view of the prop apparatus in the handrail apparatus of the present embodiment.

FIG. 4 is a front view showing part of a handrail holding member in the handrail apparatus of the present embodiment in a cutaway manner.

FIG. 5 is a front view showing part of a handrail holding member of another embodiment in a cutaway manner.

FIG. 6(A) is a front view showing part of a handrail coupling member in the handrail apparatus of the present embodiment in a cutaway manner. FIG. 6(B) is a side view of FIG. 6(A).

FIG. 7 is a reference diagram showing a state where a main rope is stretched in place of a handrail between prop apparatuses in the handrail apparatus.

FIG. 8(A) is a front view showing part of a handrail coupling member of another embodiment in a cutaway manner. FIG. 8(B) is a bottom view of FIG. 8(A).

FIG. 9(A) is a front view showing part of a handrail coupling member of still another embodiment in a cutaway manner. FIG. 9(B) is a bottom view of FIG. 9(A).

FIG. 10 is a plan view of a slider device of the present embodiment.

FIG. 11 is a side cross-sectional view of the slider device of the present embodiment.

FIG. 12 is a front view of a prop apparatus in a handrail apparatus of another embodiment.

FIG. 13 is a front view of a fixing tool in the handrail apparatus of the other embodiment.

FIG. 14 is a side view showing part of the fixing tool in the handrail apparatus of the other embodiment in a cutaway manner.

### DESCRIPTION OF EMBODIMENTS

Hereinbelow, the present embodiment is described with reference to the drawings. Identical reference symbols denoted through several drawings indicate identical parts.

A slider device 1 of the present embodiment is, in the erection site of an erection such as a multistoried building or the construction site of a construction such as a bridge, used for a handrail apparatus 10 installed at an end of a passage or the like for a worker to perform work on or pass through or near the end, on the outer periphery of a building such as the erection or the construction.

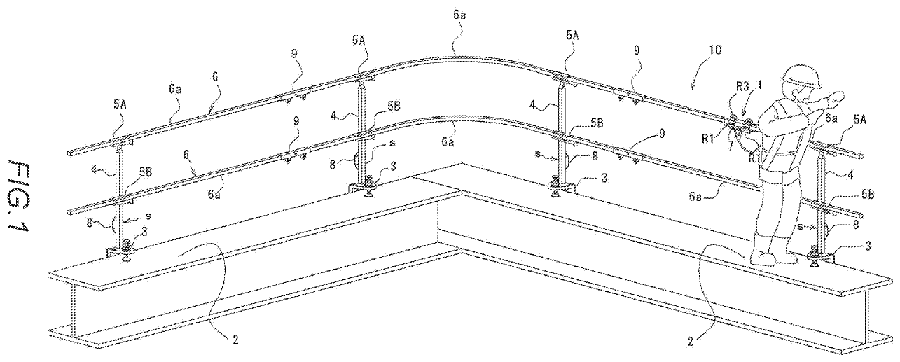

As shown in FIG. 1, the handrail apparatus 10 of the present embodiment includes: a prop apparatus S composed of a plurality of vertical props 4 each of which is attached via a fixing tool 3 to an H-shaped steel beam 2 as an attachment target member placed at an end of a passage or the like or near the end and stands and a handrail holding member 5A provided on each vertical prop 4; a handrail 6 held by the handrail holding members 5A and stretched between vertical props 4 and 4; and a slider device 1 mounted in such a manner as to be freely movable along the extending direction of the handrail 6.

The slider device 1 includes: a slider main body 7 that can move in the extending direction of the handrail 6 while holding the handrail 6; and a plurality of pairs of rollers R1 and R2 that are provided on the slider main body 7 in a plurality of places apart from each other in the extending direction of the handrail, grasp side surfaces of the handrail 6, and can travel on the side surfaces of the handrail 6.

Next, each part of the handrail apparatus 10 is described in detail. Hereinafter, for convenience of description, the side facing the building of the handrail apparatus 10 is referred to as a building side, and the opposite side is referred to as an anti-building side. Further, the front, the rear, the left, the right, the upper side, and the lower side of the handrail apparatus 10 when the handrail apparatus 10 is viewed from the building side are simply referred to as “front”, “rear”, “left”, “right”, “upper”, and “lower”.

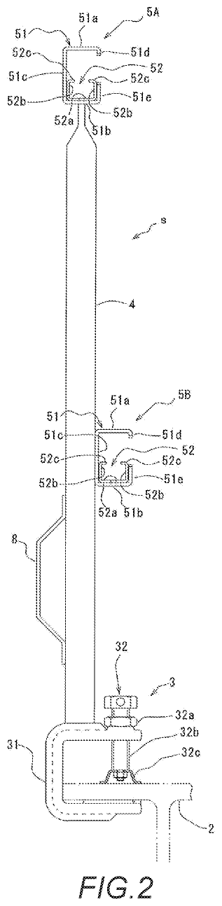

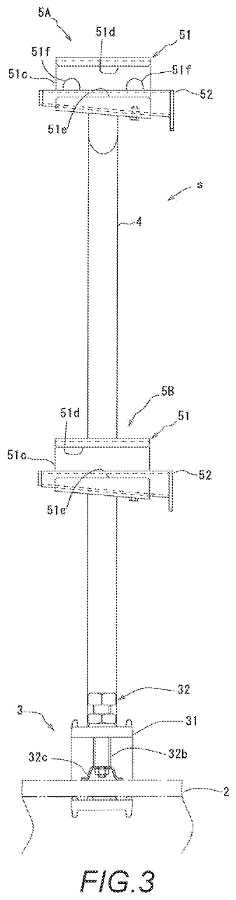

As shown in FIG. 2 and FIG. 3, the vertical prop 4 of the present embodiment is formed of a square pipe with a quadrangular cross section vertically standing from the H-shaped steel beam 2 via the fixing tool 3. A handle unit 8 is provided on the left side in FIG. 2, which is the anti-building side of the vertical prop 4, so that the vertical prop 4 can be easily carried. However, the handle unit 8 may be provided in a portion other than the anti-building side of the vertical prop 4. The cross-sectional shape of the vertical prop 4 is not limited to a quadrangular shape, and may be formed of, for example, a round pipe. Further, the vertical prop 4 may obliquely stand from the H-shaped steel beam 2 toward the anti-building side when attached to the H-shaped steel beam 2 by the fixing tool 3. Thereby, even when the width of the passage or the like is narrow, the worker can easily walk on the passage or the like.

As shown in FIG. 2, the fixing tool 3 includes: a grasping piece 31 formed in a C-shape in a side view and opened sideways; and a tightening member 32 provided on the building side (the right side in FIG. 2) of the upper wall (not denoted) that is the upper side of the grasping piece 31. The vertical prop 4 is coupled to the anti-building side (the left side in FIG. 2) of the upper wall of the grasping piece 31.

The tightening member 32 includes: a fixed nut 32a welded to the upper wall of the grasping piece 31 such that the center hole faces a through hole (not shown) penetrating the wall thickness of the upper wall of the grasping piece 31; a bolt member 32b inserted into the through hole while being screwed to the fixed nut 32a; and a dish unit 32c in a bowl shape coupled to the lower end of the bolt member 32b.

As shown in FIG. 2, when the bolt member 32b is rotated in the tightening direction in a state where the H-shaped steel beam 2 is placed between the dish unit 32c of the tightening member 32 and the lower wall (not denoted) that is the lower side of the grasping piece 31, the bolt member 32b moves downward, and the H-shaped steel beam 2 is grasped by the dish unit 32c and the lower wall of the grasping piece 31. Thereby, the fixing tool 3 can fix the vertical prop 4 to the H-shaped steel beam 2. When detaching the vertical prop 4 from the H-shaped steel beam 2, the bolt member 32b may be rotated in the opposite direction.

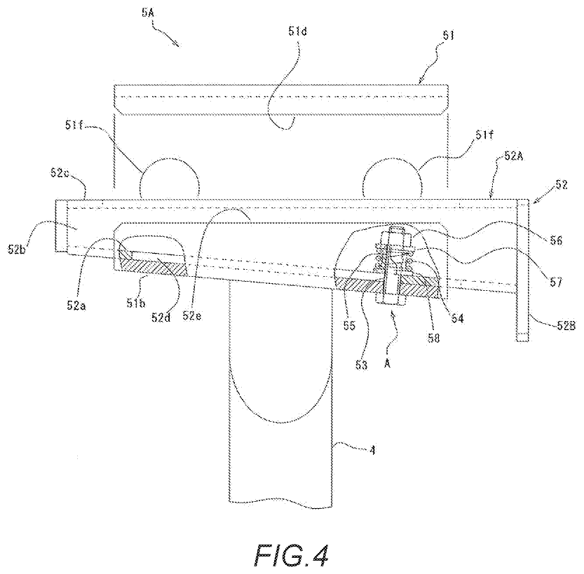

As shown in FIG. 2, the handrail holding member 5A is provided at the upper end of the vertical prop 4. As shown in FIG. 2, FIG. 3, and FIG. 4, the handrail holding member 5A includes: a socket 51 with a C-shaped cross section coupled to the vertical prop 4 such that the opening side faces the building side; a wedge 52 that can be inserted into the socket 51; and a retaining mechanism A coupling the wedge 52 to the socket 51 in a freely slidable manner and pressing the wedge 52 against the socket 51.

Specifically, the socket 51 has: an upper wall portion 51a and a lower wall portion 51b arranged facing each other in the up-down direction; a side wall portion 51c connecting one ends of the upper wall portion 51a and the lower wall portion 51b; an upper guide wall portion 51d formed by bending the other end of the upper wall portion 51a inward; and a lower guide wall portion 51e formed by bending the other end of the lower wall portion 51b inward. The upper wall portion 51a is placed to be horizontal to the vertical prop 4 and run along the left-right direction, and the lower wall portion 51b is inclined with respect to the upper wall portion 51a in a right oblique downward direction in FIG. 3 and FIG. 4. The side wall portion 51c is provided with a pair of attachment holes 51f and 51f arranged side by side in the left-right direction as viewed from the building side.

As shown in FIG. 2 and FIG. 4, the wedge 52 includes a wedge main body 52A that has a bottom plate portion 52a inclined to run along the lower wall portion 51b of the socket 51, side plate portions 52b and 52b vertically standing from side end portions of the bottom plate portion 52a, and protruding plate portions 52c protruding inward perpendicularly from end portions of the side plate portions 52b on the opposite side to the bottom plate portion and facing the upper wall portion 51a of the socket 51 and that is formed with a C-shaped cross section. The right end in FIG. 4, which is the root end of the wedge main body 52A, is provided with a closing plate 52B in a flat plate shape closing the right opening of the wedge main body 52A.

As shown in FIG. 4, the retaining mechanism A includes: a long hole 52d formed in the bottom plate portion 52a of the wedge 52 and formed along the insertion direction of the wedge 52; a bolt shaft 53 penetrating the lower wall portion 51b of the socket 51, protruding inward, and inserted into the long hole 52d of the wedge 52; a coil spring 54 mounted on the outer periphery of the bolt shaft 53; a spacer 55 in a cylindrical shape mounted between the outer periphery of the bolt shaft 53 and the inside of the coil spring 54; and a nut 56 screwed to an end portion of the bolt shaft 53 and applying a compressive load to the coil spring 54. An upper washer 57 is interposed between the coil spring 54 and the spacer 55, and the nut 56. On the other hand, a lower washer 58 is interposed between the coil spring 54 and the spacer 55, and the bottom plate portion 52a.

Next, an assembly procedure of the retaining mechanism A is described. First, the bolt shaft 53 is inserted into the long hole 52d of the wedge 52. After that, the lower washer 58, the spacer 55, the coil spring 54, and the upper washer 57 are mounted in this order on the bolt shaft 53. Then, the nut 56 is tightened until the spacer 55 is grasped between the upper washer 57 and the lower washer 58. Finally, the nut 56 is loosened by about half a rotation so that the tightening load of the nut 56 does not act on the bottom plate portion 52a of the wedge 52 via the spacer 55. Thus, since only the biasing force of the coil spring 54 acts on the bottom plate portion 52a of the wedge 52, the wedge 52 can slidingly move in the left-right direction in the socket 51 while being pressed against the lower wall portion 51b of the socket 51 by the coil spring 54.

Thus, the retaining mechanism A couples the wedge 52 into the socket 51 in a freely slidable manner, and presses the wedge 52 against the socket 51 to generate large frictional force between the wedge 52 and the socket 51; therefore, can suppress the sliding movement of the wedge 52 with respect to the socket 51.

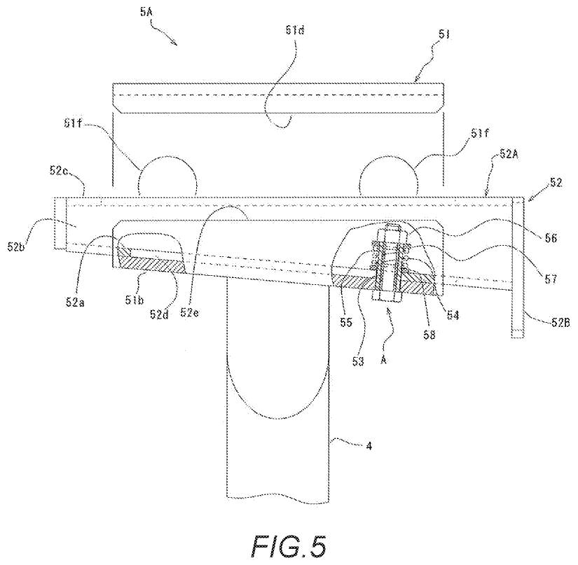

In the present embodiment shown in FIG. 4, the spacer 55 is interposed between the nut 56 and the bottom plate portion 52a of the wedge 52 via the washers 57 and 58; however, as shown in FIG. 5, the inner diameter of the lower washer 58 may be set to a size allowing insertion of the spacer 55, and the spacer 55 may be inserted into the inner periphery of the lower washer 58 to be interposed between the nut 56 and the bolt head of the bolt shaft 53. Alternatively, although not illustrated, the spacer 55 may be interposed between the nut 56 and the lower wall portion 51b of the socket 51. Thereby, when the nut 56 is tightened, the tightening load of the nut 56 does not act on the bottom plate portion 52a of the wedge 52, and therefore the work of loosening the nut 56 by about half a rotation after tightening can be omitted.

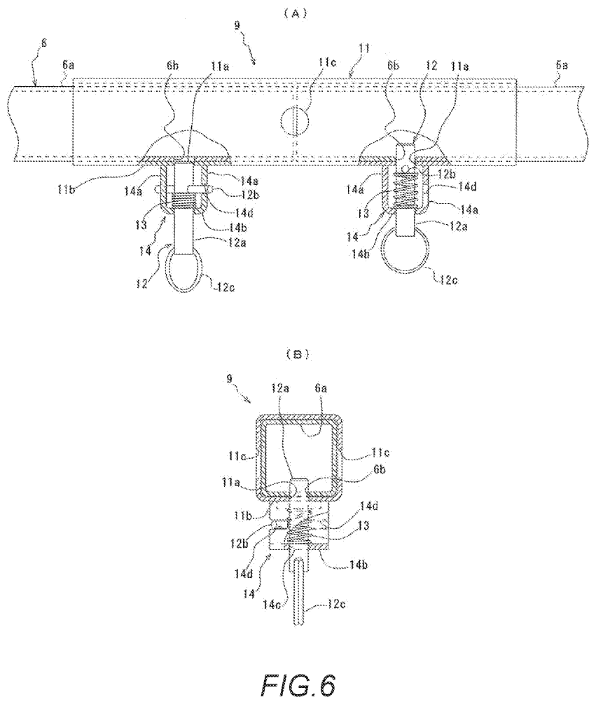

As shown in FIG. 1, the handrail 6 includes: a plurality of bar members 6a each formed of a pipe member with a quadrangular cross section; and a handrail coupling member 9 coupling end portions facing each other of adjacent bar members 6a. As shown in FIG. 6, insertion holes 6b are formed in the lower wall of end portions of the bar member 6a. As shown in FIG. 1, types of the bar member 6a include a type having a straight-lined shape extending along the extending direction of the H-shaped steel beam 2 and a type having a shape curved according to a portion such as a corner of a passage or the like. Therefore, by combining these bar members 6a and 6a, the handrail 6 can be placed along the traveling direction of a passage or the like as shown in FIG. 1.

When causing the handrail holding member 51A to hold the handrail 6, the closing plate 52e of the wedge 52 is hit with a tool such as a hammer in a state where the handrail 6 is inserted into the socket 51, and the wedge 52 is driven between the lower wall portion 51b of the socket 51 and the handrail 6. Thereby, the handrail 6 is grasped between the upper wall portion 51a of the socket 51 and the wedge 52; thus, the handrail holding member 51A can hold the handrail 6. Furthermore, since the wedge 52 is constantly pressed against the socket 51 by the biasing force of the coil spring 54, the frictional force generated between the wedge 52 and the socket 51 is increased. Thus, the retaining mechanism A can reliably prevent an event where the wedge 52 press-fitted between the socket 51 and the handrail 6 loosens and comes off due to vibration or the like.

The biasing force of the coil spring 54 is determined by the tightening amount of the nut 56; in the present embodiment, since the spacer 55 in a cylindrical shape is provided on the outer periphery of the bolt shaft 53, the tightening amount of the nut 56 is constantly fixed by tightening the nut 56 via the upper washer 57 until the nut 56 abuts the spacer 55. Therefore, the biasing force of the coil spring 54 does not vary. Although in the present embodiment the nut 56 is loosened by about half a rotation after tightening, the biasing force of the coil spring 54 hardly varies because of loosening by only about half a rotation.

Although the spacer 55 may be provided on the outer periphery of the coil spring 54, the diameter of the spacer 55 can be reduced when it is provided on the inner periphery of the coil spring 54. One or both of the washers 57 and 58 may be omitted, and the coil spring 54 may be interposed directly between the nut 56 and the wedge 52. However, when the upper washer 57 is interposed between the coil spring 54 and the nut 56, the rotational force generated when the coil spring 54 exerts resilient force acts on the upper washer 57, and therefore the rotational force is prevented from acting on the nut 56; thus, the nut 56 can be prevented from loosening. Further, when the lower washer 58 is interposed between the coil spring 54 and the bottom plate portion 52a, the coil spring 54 can be prevented from cutting into the bottom plate portion 52a.

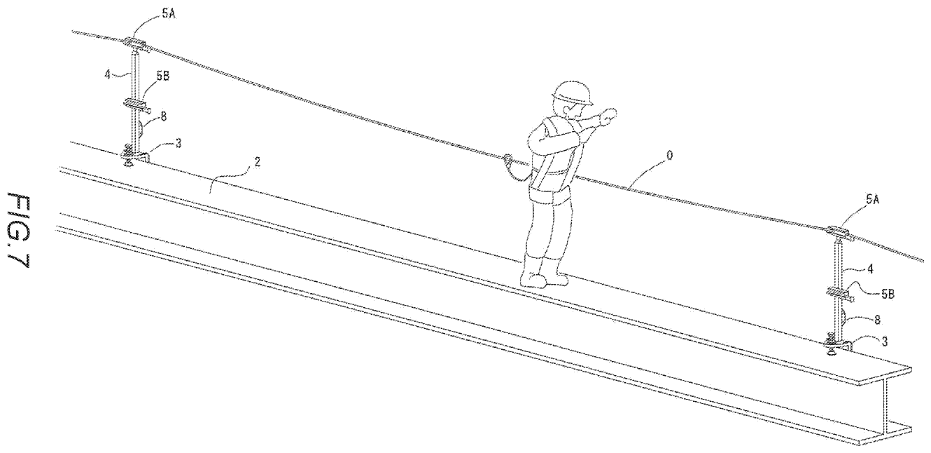

The socket 51 of the handrail holding member 5A of the present embodiment is provided with a pair of attachment holes 51f and 51f arranged side by side in the left-right direction. A not-illustrated shackle is fitted into the attachment holes 51f, and a main rope O provided with a not-illustrated thimble at each end is attached to the shackle via the thimble. Thereby, as shown in FIG. 7, the handrail holding member 5A also makes it possible to stretch the main rope O in place of the handrail 6 between adjacent prop apparatuses S and S.

In the present embodiment, as shown in FIG. 2 and FIG. 3, a handrail holding member 5B is provided also at an intermediate position of the vertical prop 4. The configuration of the handrail holding member 5B is the same as the configuration of the handrail holding member 5A provided at the upper end of the vertical prop 4 except that the handrail holding member 5B does not have the attachment hole 51f, and thus a description thereof is omitted. The number of handrail holding members 5A and 5B provided on the vertical prop 4 may be appropriately determined, and the handrail holding member 5B placed at an intermediate position of the vertical prop 4 may be omitted.

As shown in FIGS. 6(A) and 6(B), the handrail coupling member 9 has: a cylindrical body 11 into which the bar member 6a can be inserted; a pair of opening holes 11a and 11a provided along the axial direction of the cylindrical body 11; pin rods 12 as stop pins inserted into the opening holes 11a in such a manner as to freely exit or enter; and coil springs 13 as spring members biasing the pin rods 12 in the insertion directions.

Specifically, as shown in FIGS. 6(A) and 6(B), the cylindrical body 11 is a pipe member with a quadrangular cross section, and is formed such that the bar member 6a can be inserted in a freely slidable manner. The pair of opening holes 11a and 11a are provided in the lower wall 11b of the cylindrical body 11. A window 11c through which the inside of the cylindrical body 11 can be seen from the outside is provided at the center of the cylindrical body 11.

As shown in FIGS. 6(A) and 6(B), the cylindrical body 11 is provided with, for each opening hole 11a, a case 14 that has a pair of vertical pieces 14a and 14a vertically standing from the outer periphery of the cylindrical body 11 and facing each other across the opening hole 11a and a connection piece 14b connecting end portions of the vertical pieces 14a and 14a and that holds the pin rod 12. The connection piece 14b of the case 14 is provided with a pin hole 14c at a position facing the opening hole 11a. As shown in FIG. 6(B), each vertical piece 14a includes a recessed groove 14d cut from one end side and running orthogonal to the axial direction of the pin rod 12. That is, the recessed grooves 14d are formed on the vertical pieces 14a in positions point-symmetric to each other around the axis of the pin rod 12.

As shown in FIG. 6(A), the pin rod 12 has: a pin main body 12a of which a terminal end portion is inserted into the pin hole 14c provided in the case 14 and the opening hole 11a provided in the cylindrical body 11 in such a manner as to freely exit or enter; a stopper 12b in a shaft shape penetrating the pin main body 12a in a radial direction; and a ring 12c as a handle provided at the root end of the pin main body 12a. When the pin rod 12 is rotated around the axis to hook the stopper 12b to the recessed grooves 14d of the case 14, the pin rod 12 is fixed at a position not inserted into the opening hole 11a.

The coil spring 13 is interposed between the stopper 12b of the pin rod 12 and the connection piece 14b of the case 14, and biases the pin rod 12 in the direction of insertion into the opening hole 11a.

Next, a procedure of coupling end portions of adjacent bar members 6a and 6a by means of the handrail coupling member 9 is described. First, bar members 6a and 6a are inserted from both sides of the cylindrical body 11; then, while the positions of the bar members 6a and 6a are visually checked through the window 11c, end portions of the bar members 6a and 6a are made to face each other at the central position of the cylindrical body 11, and the insertion holes 6b of the bar members 6a and the opening holes 11a of the cylindrical body 11 are made to face each other. Here, the insertion hole 6b of the bar member 6a is provided in such a manner as to face the opening hole 11a of the cylindrical body 11 when the end of the bar member 6a is inserted to near the center of the cylindrical body 11. In the present embodiment, since a window 11c through which the inside can be seen is provided at the center of the cylindrical body 11, how much the bar member 6a is inserted into the cylindrical body 11 can be visually identified. Thus, the insertion hole 6b of the bar member 6a and the opening hole 11a of the cylindrical body 11 can be easily made to face each other.

Next, the pin rod 12 is rotated around the axis to remove the stopper 12b from the recessed grooves 14d of the case 14. Then, the pin main bodies 12a of the pin rods 12 are inserted into the insertion holes 6b of the bar members 6a and the opening holes 11a of the cylindrical body 11 in a state where the insertion holes 6b and the opening holes 11a are made to face each other; thereby, the end portions of the adjacent bar members 6a and 6a are fixed to the cylindrical body 11; thus, the end portions of the adjacent bar members 6a are coupled via the cylindrical body 11.

At this time, since the coil spring 13 biases the pin rod 12 in the insertion direction in such a manner as to press the stopper 12b against the outer periphery of the cylindrical body 11, the pin rod 12 does not come off from the insertion hole 6b or the opening hole 11a (see the pin rod 12 on the right side in FIG. 6(A)).

Conversely, when releasing the coupling between the end portions of the adjacent bar members 6a and 6a, the ring 12c is gripped to pull out the pin rod 12 against the biasing force of the coil spring 13, and the pin rod 12 is rotated around the axis to hook the stopper 12b of the pin rod 12 to the recessed grooves 14d provided in the case 14 to fix the pin rod 12. Thereby, the case 14 can hold the pin rod 12 in a state where the pin rod 12 is pulled out from the insertion hole 6b and the opening hole 11a (see the pin rod 12 on the left side in FIG. 6(A)).

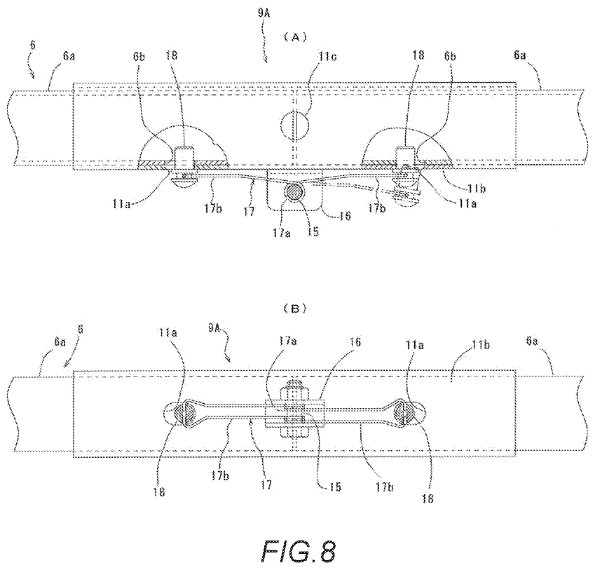

The configuration of the handrail coupling member 9 shown in FIG. 6 is an example, and the handrail coupling member 9 is not limited to the above configuration. For example, as another embodiment, as shown in FIGS. 8(A) and 8(B), a handrail coupling member 9A may have: a support shaft 15 provided between the opening holes 11a and 11a in the lower wall 11b of the cylindrical body 11 and extending in a direction crossing the extending direction of the cylindrical body 11 at a right angle; a first bracket 16 holding the support shaft 15; a torsion coil spring 17 as a spring member having a coil portion 17a wound and fixed around the support shaft 15 and arm portions 17b extending from both end portions of the coil portion 17a; and first pin members 18 as stop pins fixed to the arm portions 17b and biased by the torsion coil spring 17 to be inserted into the opening holes 11a of the cylindrical body 11.

A procedure of coupling end portions of adjacent bar members 6a and 6a by means of the handrail coupling member 9A will now be described. First, as indicated by the broken lines in FIG. 8(A), bar members 6a are inserted into the cylindrical body 11 in a state where the first pin members 18 are pulled out from the opening holes 11a against the biasing force of the torsion coil spring 17. Then, the bar members 6a are gradually inserted into the cylindrical body 11 while the terminal ends of the first pin members 18 are kept in contact with the outer periphery of the cylindrical body 11; then, when the insertion holes 6b and the opening holes 11a face each other, the first pin members 18 are automatically inserted into the insertion holes 6b by the biasing force of the torsion coil spring 17; thus, end portions of the adjacent bar members 6a and 6a are coupled via the cylindrical body 11.

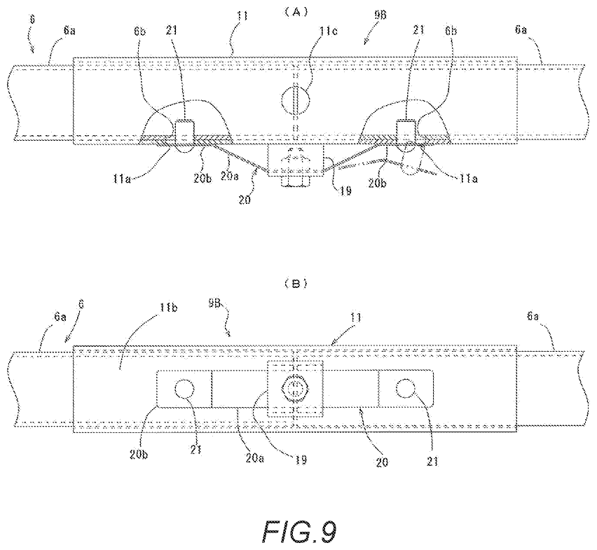

As still another embodiment, as shown in FIGS. 9(A) and 9(B), a handrail coupling member 9B may have: a second bracket 19 provided between the opening holes 11a and 11a in the lower wall 11b of the cylindrical body 11; a leaf spring 20 as a spring member having a spring main body 20a with a trapezoidal shape in a front view held by the second bracket 19 and support portions 20b extending from both end portions of the spring main body 20a along the axial direction of the cylindrical body 11; and second pin members 21 as stop pins fixed to the support portions 20b and biased by the leaf spring 20 to be inserted into the opening holes 11a of the cylindrical body 11.

A procedure of coupling end portions of adjacent bar members 6a and 6a by means of the handrail coupling member 9B is similar to the procedure of the handrail coupling member 9A of the other embodiment shown in FIG. 8.

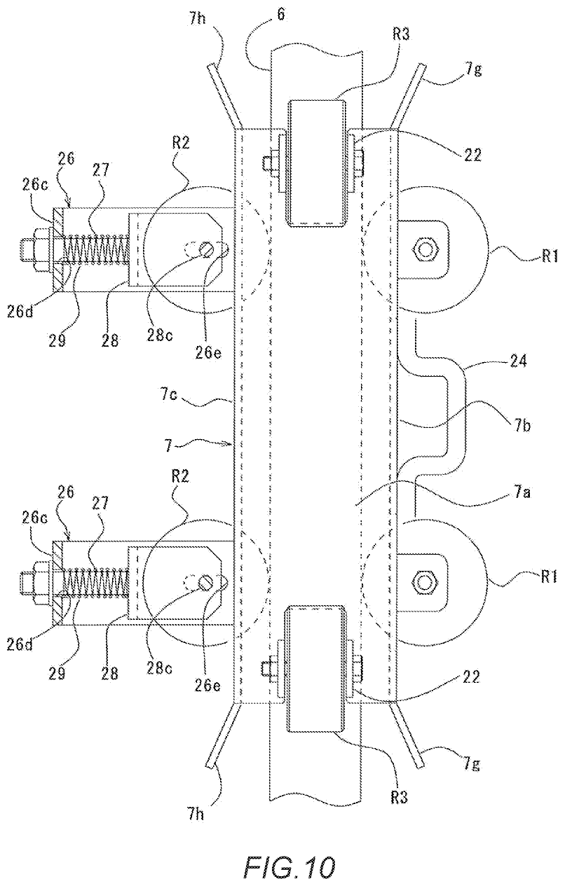

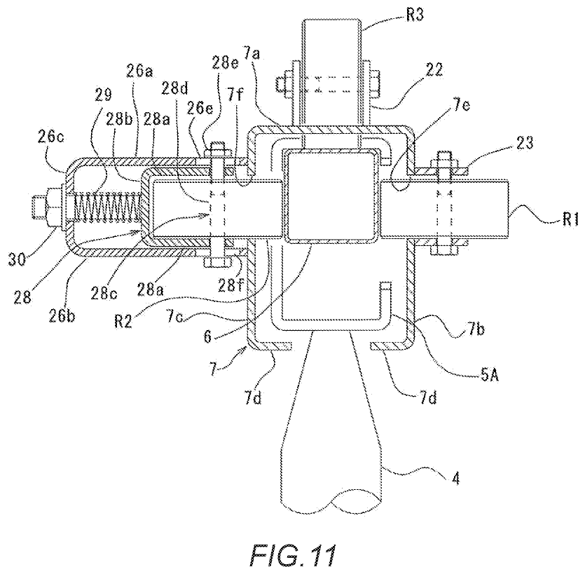

Next, the slider device 1 of the present embodiment is described in detail. The slider device 1 of the present embodiment is mounted in such a manner as to be freely movable along the extending direction of the handrail 6 stretched between handrail holding members 5A and 5A provided at the upper ends of vertical props 4. As shown in FIG. 10 and FIG. 11, the slider device 1 includes: a slider main body 7 that can move in the extending direction of the handrail 6 while holding the handrail 6; and two pairs of rollers R1 and R2 that are provided on the slider main body 7 to be apart from each other in the extending direction of the handrail 6, grasp side surfaces of the handrail 6, and can travel on the side surfaces of the handrail 6.

Specifically, as shown in FIG. 10 and FIG. 11, the slider main body 7 has: an upper wall portion 7a extending along the extending direction of the handrail 6 and having a width larger than the lateral width of the handrail 6; a pair of side wall portions 7b and 7c extending vertically downward from the side ends of the upper wall portion 7a; and a pair of protruding portions 7d and 7d protruding mutually inward from the lower ends of the side wall portions 7b and 7c, and is formed with a C-shaped cross section. The distance between the protruding portions 7d and 7d is set shorter than the lateral width of the handrail 6, and therefore the slider device 1 does not fall off from the handrail 6. Further, as shown in FIG. 11, the distance between the protruding portions 7d and 7d is longer than the width of the upper end of the vertical prop 4. Thereby, when the slider device 1 travels on a portion of the handrail 6 on the vertical prop 4, the vertical prop 4 passes through the space between the protruding portions 7d and 7d. Therefore, the slider device 1 can travel on the portion of the handrail 6 on the vertical prop 4. The shape of the slider main body 7 is not limited to the above shape, and may be any shape as long as the slider main body 7 can hold the handrail 6 and travel on a portion of the handrail 6 on the vertical prop 4.

As shown in FIG. 10 and FIG. 11, a notch (not shown), an upper roller R3 that is inserted into the notch and can travel on the upper surface of the handrail 6, and an upper roller bracket 22 holding the upper roller R3 in a freely rotatable manner are provided on each of the front side and the rear side of the upper wall portion 7a of the slider main body 7 with respect to the traveling direction of the slider device 1.

As shown in FIG. 11, one side wall portion 7b and the other side wall portion 7c of the slider main body 7 are provided with two openings 7e and two openings 7f facing each other, respectively, along the front-rear direction of the slider main body 7. As shown in FIG. 10, the front ends and the rear ends of the one side wall portion 7b and the other side wall portion 7c of the slider main body 7 are provided with a pair of guide plate portions 7g and a pair of guide plate portions 7h extending obliquely to be apart mutually outward, respectively. Even if, for example, adjacent handrails 6 and 6 are not coupled by the handrail coupling member 9 and are displaced in the front-rear direction as viewed from the building side, when the slider main body 7 moves from a handrail 6 to the adjacent handrail 6, the guide plate portions 7g and 7h guide the slider main body 7 to smoothly achieve movement between the handrails 6 and 6. As shown in FIG. 10 and FIG. 11, the one side wall portion 7b of the slider main body 7 is provided with fixed rollers R1 that can travel on one side surface of the handrail 6 through the openings 7e and fixed-roller brackets 23 holding the fixed rollers R1 in a freely rotatable manner. A lifeline attachment unit 24 to which a lifeline can be attached is provided between the fixed rollers R1 and R1 of the one side wall portion 7b of the slider main body 7.

On the other hand, as shown in FIG. 10 and FIG. 11, the other side wall portion 7c of the slider main body 7 is provided with movable rollers R2 that can travel on the other side surface of the handrail 6 through the openings 7f and one movable-roller bracket 25 supporting the movable roller R2 such that the movable roller R2 can get farther or closer with respect to the handrail 6, that is, a total of two movable-roller brackets. The movable-roller bracket 25 includes a spring case 26 having an upper plate portion 26a and a lower plate portion 26b that have long holes 26e and 26f standing perpendicularly from the upper and lower sides of the opening 7f in the other side wall portion 7c of the slider main body 7 and facing each other, respectively, and a bottom plate portion 26c connecting end portions of the plate portions 26a and 26b and having an opening hole 26d. The movable-roller bracket 25 further includes: a movable bracket 28 slidably mounted in the spring case 26 and holding the movable roller R2 in a freely rotatable manner; and a rod 27 coupled to the movable bracket 28 and inserted into the opening hole 26d of the spring case 26. In addition, the movable-roller bracket 25 includes a coil spring 29 as a biasing member mounted on the outer periphery of the rod 27, interposed between the bottom plate portion 26c of the spring case 26 and the movable bracket 28, and biasing the movable roller R2 toward the handrail 6 via the movable bracket 28.

Specifically, as shown in FIG. 11, the movable bracket 28 has: a pair of flat plate portions 28a and 28a facing each other in the up-down direction; and a connection plate portion 28b connecting one ends of the flat plate portions 28a, is formed with a C-shaped cross section, and is inserted into the spring case 26 in a freely slidable manner. A rotation shaft 28c supporting the movable roller R2 in a freely rotatable manner is stretched between the flat plate portions 28a and 28a facing each other. One end of the rod 27 is coupled to the connection plate portion 28b of the movable bracket 28 by welding.

The root end of the rod 27 is provided with a stopper ring 30 having an outer diameter larger than the diameter of the opening hole 26d, so that the movable bracket 28 can move in the spring case 26 without falling off from the spring case 26. As shown in FIG. 11, the stopper ring 30 may be provided by providing a screw groove at the root end of the rod 27 and screwing the stopper ring 30 to the screw groove. Alternatively, although not illustrated, the stopper ring 30 may be provided by being welded to the root end of the rod 27.

The flat plate portions 28a and 28a of the movable bracket 28 are in sliding contact with the upper plate portion 26a and the lower plate portion 26b of the spring case 26, respectively; therefore, when the movable bracket 28 moves in the spring case 26, the movable bracket 28 is blocked from rotation so as not to rotate in the circumferential direction.

In the present embodiment, as shown in FIG. 11, the rotation shaft 28c stretched between the flat plate portions 28a and 28a of the movable bracket 28 is composed of a bolt 28d penetrating both flat plate portions 28a and 28a and a nut 28e screwed to the terminal end of the bolt 28d to fix the bolt 28d to the flat plate portions 28a, and the rotation shaft 28c protrudes from the flat plate portions 28a in the up-down direction in the drawing sheet and protrudes to the outside of the spring case 26 through the long holes 26e and 26f provided in the spring case 26. Here, the long holes 26e and 26f provided in the upper plate portion 26a and the lower plate portion 26b of the spring case 26 are provided along the moving direction of the movable bracket 28, and each has such a length as not to interfere with the rotation shaft 28c in a range in which the movement of the movable bracket 28 is allowed.

Thereby, since the rotation shaft 28c does not interfere with the spring case 26, the movable bracket 28 can move parallel in the spring case 26 in the left-right direction in the drawing sheet. However, in the case where the rotation shaft 28c does not protrude from the flat plate portions 28a, the long holes 26e and 26f may be omitted.

Thus, the slider device 1 of the present embodiment includes: two upper rollers R3 that can travel on the upper surface of the handrail 6; two fixed rollers R1 that can travel on one side surface of the handrail 6; and two movable rollers R2 that grasp the handrail 6 together with the fixed rollers R1 and can travel on the other side surface of the handrail 6. The slider device 1 can move along the extending direction of the handrail 6 by being made to travel on the outer periphery of the handrail 6 by means of the rollers R1, R2, and R3.

The movable roller R2 is supported by the movable-roller bracket 25 in such a manner as to be able to get farther or closer with respect to the handrail 6, and is biased toward the handrail 6 by the coil spring 29. Therefore, when the slider device 1 passes through a portion that hinders smooth traveling of the slider device 1, such as a curved portion of the handrail 6 or an uneven portion of the handrail holding member 5A or the handrail coupling member 9, the movable roller R2 gets farther or closer according to the shape of the portion that hinders smooth traveling. Therefore, the slider device 1 of the present embodiment, when traveling on a curved portion of the handrail 6, can move along the curve, and when passing through a portion with an obstacle such as the handrail holding member 5A or the handrail coupling member 9, can move over the obstacle. In addition, since each movable roller R2 is biased by the coil spring 29 in the slider device 1 of the present embodiment, the slider device 1 can firmly grasp the handrail 6 by means of the fixed roller R1 and the movable roller R2. The configuration of the movable-roller bracket 25 of the present embodiment is an example, and the movable-roller bracket 25 is not limited to this configuration.

As described above, the slider device 1 of the present embodiment includes: a slider main body 7 that can move in the extending direction of the handrail 6 while holding the handrail 6; and two pairs of rollers R1 and R2 that are provided on the slider main body 7 in two places apart from each other in the extending direction of the handrail 6, grasp side surfaces of the handrail 6, and can travel on the side surfaces of the handrail 6; one of the rollers facing each other across the handrail 6 is a fixed roller R1 fixed to the slider main body 7 and the other of the rollers facing each other across the handrail 6 is a movable roller R2 supported in such a manner as to be able to get farther or closer with respect to the handrail 6, and each movable roller R2 is biased toward the handrail 6 by a coil spring 29 as a biasing member.

In the case of this configuration, the movable roller R2 is supported on the slider main body 7 in such a manner as to be able to get farther or closer with respect to the handrail 6, and is biased toward the handrail 6 by the coil spring 29; therefore, when the slider device 1 passes through a portion that hinders smooth traveling of the slider device 1, such as a curved portion of the handrail 6 or an uneven portion such as the handrail holding member 5A or the handrail coupling member 9, the movable roller R2 gets farther or closer according to the shape of the portion that hinders smooth traveling. Therefore, the slider device 1 can pass even through the shape of a portion of the handrail 6 that hinders traveling.

Furthermore, in the present invention, each movable roller R2 is biased toward the handrail 6 by the coil spring 29, and the followability of the movable roller R2 to the handrail 6 is increased; therefore, when the slider device 1 moves on the handrail 6, an event where a gap is generated between the movable roller R2 and the handrail 6 and rattling occurs can be prevented.

Although in the present embodiment the slider main body 7 is provided with two pairs of rollers (fixed rollers R1 and movable rollers R2) facing each other across side surfaces of the handrail 6, three or more pairs may be provided. Further, although in the present embodiment the roller placed on the right side of the slider main body 7 in FIG. 10 is a fixed roller R1 and the roller placed on the left side of the slider main body 7 in FIG. 10 is a movable roller R2, the fixed roller R1 and the movable roller R2 may be exchanged, or the fixed roller R1 and the movable roller R2 may be arranged alternately in the left-right direction. Further, the biasing member is not limited to the coil spring 29, and may be, for example, rubber as long as it biases the movable roller R2 toward the handrail 6.

The handrail apparatus 10 of the present embodiment includes: a plurality of vertical props 4 attached to an H-shaped steel beam 2 as an attachment target member and standing; a handrail holding member 5A provided on each vertical prop 4; a handrail 6 held by the handrail holding members 5A and stretched between vertical props 4 and 4; and a slider device 1 mounted in such a manner as to be freely movable along the extending direction of the handrail 6.

In the case of this configuration, since the slider device 1 can pass even through the shape of a portion of the handrail 6 that hinders traveling, the worker can smoothly move on the passage or the like in a state where a lifeline is attached to the slider device 1.

Each of the handrail holding members 5A and 5B of the present embodiment has: a socket 51 that is coupled to the vertical prop 4 and into which the handrail 6 can be inserted; a wedge 52 that is inserted into the socket 51 and can grasp the handrail 6 together with the socket 51; and a retaining mechanism A coupling the wedge 52 to the socket 51 in a freely slidable manner and pressing the wedge 52 against the socket 51; the retaining mechanism A has: a long hole 52f formed in the wedge 52 along the insertion direction of the wedge 52; a bolt shaft 53 protruding inward from the socket 51 and inserted into the long hole 52f of the wedge 52; a coil spring 54 mounted on the outer periphery of the bolt shaft 53; and a nut 56 screwed to an end portion of the bolt shaft 53 and applying a compressive load to the coil spring 54.

In the case of this configuration, since the wedge 52 is constantly pressed against the socket 51 by the coil spring 54, the wedge 52 can be prevented from coming off after the wedge 52 is inserted between the socket 51 and the handrail 6 to couple the handrail 6 to the vertical prop 4. Although in the present embodiment the wedge 52 is press-fitted between the lower wall portion 51b of the socket 51 and the handrail 6, the wedge 52 may be provided along the upper wall portion 51a of the socket 51 and be press-fitted between the upper wall portion 51a of the socket 51 and the handrail 6.

In the present embodiment, a spacer 55 in a cylindrical shape that regulates the movement in the tightening direction of the nut 56 is mounted on the outer periphery of the bolt shaft 53. In the case of this configuration, the tightening amount of the nut 56 is constantly fixed by tightening the nut 56 until it abuts the spacer 55, and therefore the biasing force of the coil spring 54 does not vary. Although in the present embodiment the nut 56 is loosened by about half a rotation after tightening, the biasing force of the coil spring 54 hardly varies because of loosening by only about half a rotation.

In the handrail apparatus 10 of the present embodiment, the handrail 6 has: a plurality of bar members 6a and 6a held by the handrail holding members 5A and 5B and each provided with insertion holes 6b in both end portions; and a handrail coupling member 9 coupling end portions facing each other of adjacent bar members 6a and 6a; the handrail coupling member 9 has: a cylindrical body 11 into which the bar member 6a can be inserted; a pair of opening holes 11a provided in the cylindrical body 11 along the axial direction; stop pins (pin rods 12) inserted into the opening holes 11a in such a manner as to freely exit or enter; and spring members (coil springs 13) biasing the stop pins in the insertion directions, and couples end portions of adjacent bar members 6a and 6a by a process in which the end portions of the adjacent bar members 6a are inserted into the cylindrical body 11 from both sides and the stop pins are inserted into the insertion holes 6b of the bar members 6a and the opening holes 11a of the cylindrical body 11 in a state where the insertion holes 6b and the opening holes 11a are made to face each other.

In the case of this configuration, end portions of adjacent bar members 6a can be easily coupled by simply inserting the bar members 6a into the cylindrical body 11 and inserting the stop pins into the insertion holes 6b of the bar members 6a and the opening holes 11a of the cylindrical body 11 in a state where the insertion holes 6b and the opening holes 11a are made to face each other. When disassembling the handrail 6, it is necessary only to pull out the stop pin against the biasing force of the spring member, and no tool is needed; therefore, operability is excellent, and workability is improved. Furthermore, since the handrail coupling member 9 needs only to include a cylindrical body 11, stop pins, and spring members, the structure is simple and economic efficiency is excellent.

Next, a handrail apparatus 10A according to another embodiment of the present invention is described. The configuration of the handrail apparatus 10A of the present embodiment is similar to that of the handrail apparatus 10 of the above-described embodiment except for the configuration of the fixing tool 3. Hereinafter, configurations different from those of the above-described embodiment are described, and common configurations are denoted by the same reference symbols and a detailed description thereof is omitted.

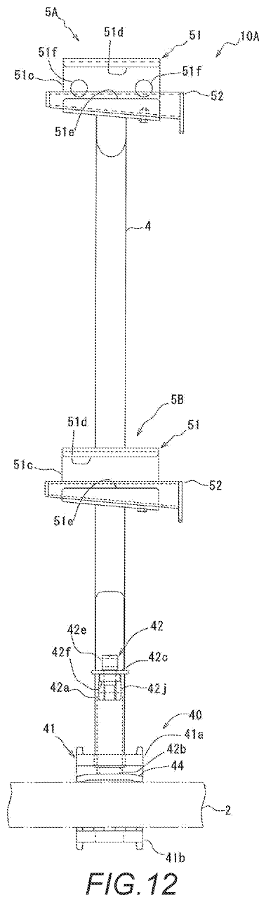

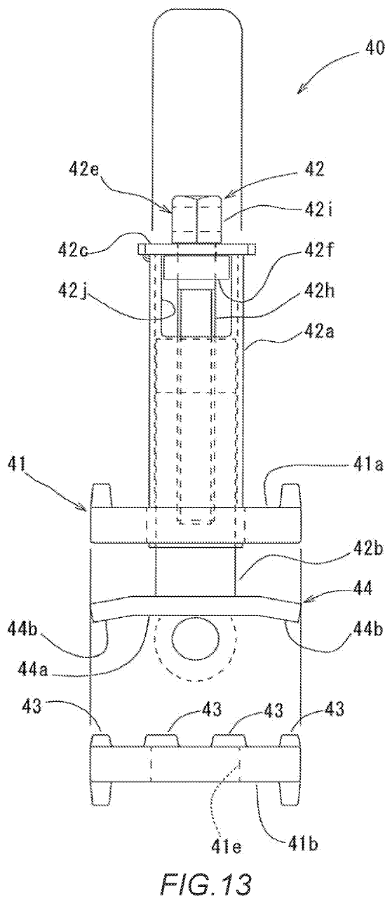

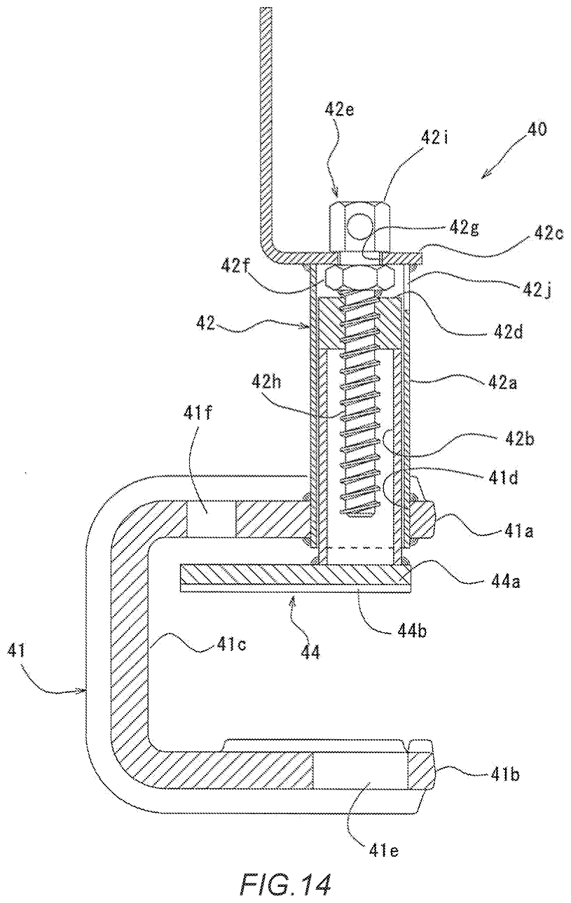

As shown in FIG. 12, FIG. 13, and FIG. 14, a fixing tool 40 of the present embodiment has: a main body portion 41 that has a support piece 41a and a fixed grasping piece 41b arranged facing each other with a predetermined gap and a coupling piece 41c coupling one end of the support piece 41a and one end of the fixed grasping piece 41b and to which the vertical prop 4 is fixed; a movable grasping piece 44 inserted between the support piece 41a and the fixed grasping piece 41b of the main body portion 41 in such a manner as to be movable in the up-down direction; and an operating unit 42 that is attached to the support piece 41a and moves the movable grasping piece 44 in the up-down direction. In FIG. 13 and FIG. 14, only the fixing tool 40 of the present embodiment is shown, and the vertical prop 4 and the H-shaped steel beam 2 are omitted.

The main body portion 41 is made of metal and formed by forging or the like, and is in a C-shape in a side view in which the support piece 41a, the fixed grasping piece 41b, and the coupling piece 41c are seamlessly integrated. The fixed grasping piece 41b of the main body portion 41 is provided with a plurality of ribs 43 for reinforcement along the front-rear direction as viewed from the building side. Thereby, the fixed grasping piece 41b is less likely to bend in the front-rear direction as viewed from the building side. The material and molding method of the main body portion 41 and the position, number, and shape of the rib 43 may be appropriately changed. Further, the support piece 41a, the fixed grasping piece 41b, and the coupling piece 41c may be partially formed separately, and be fixedly joined to other portions by welding or the like to be integrated as the main body portion 41.

An attachment hole 41d and an insertion hole 41e for attaching the operating unit 42 are formed in the support piece 41a and the fixed grasping piece 41b of the main body portion 41, respectively. A hole 41f is formed in a portion of the support piece 41a on the anti-building side of the attachment hole 41d, and the lower end of the vertical prop 4 is fixedly joined to an edge portion of the hole 41f by welding or the like. Thereby, the vertical prop 4 stands on the support piece 41a.

The operating unit 42 has: an outer cylinder 42a in a quadrangular cylindrical shape inserted into the attachment hole 41d and fixed to the support piece 41a in a standing state; a movable shaft 42b in a circular cylindrical shape inserted into the outer cylinder 42a in such a manner as to be movable in the axial direction; a lid portion 42c closing the upper end of the outer cylinder 42a; a nut 42d fixed to the upper end of the movable shaft 42b; a bolt 42e penetrating the lid portion 42c, inserted into the outer cylinder 42a, and screwed to the nut 42d; and a retaining ring 42f located between the lid portion 42c and the nut 42d and fixed to the bolt 42e. The attachment hole 41d formed in the support piece 41a is in a shape corresponding with the outer peripheral shape of the outer cylinder 42a, a lower end portion of the outer cylinder 42a is inserted into the attachment hole 41d, and the upper and lower edges of the attachment hole 41d and the outer periphery of the outer cylinder 42a are welded.

The lid portion 42c is in an L-shape, and the surfaces are welded to the outer periphery of the vertical prop 4 and the upper end of the outer cylinder 42a. An insertion hole 42g penetrating the wall thickness of the lid portion 42c is formed at the center of a portion of the lid portion 42c welded to the upper end of the outer cylinder 42a, and a screw shaft 42h of the bolt 42e is inserted into the insertion hole 42g. The bolt 42e includes: the screw shaft 42h; and a bolt head 42i located at the terminal end of the screw shaft 42h and having an outer diameter larger than the outer diameter of the screw shaft 42h. The diameter of the insertion hole 42g is smaller than the outer diameter of the bolt head 42i. Therefore, when the screw shaft 42h of the bolt 42e is inserted into the outer cylinder 42a from above the lid portion 42c, the bolt head 42i is caught by the lid portion 42c, and only the screw shaft 42h is inserted into the outer cylinder 42a.

The retaining ring 42f is welded to the outer periphery of the screw shaft 42h inserted into the outer cylinder 42a, in the vicinity of the lid portion 42c. The outer diameter of the retaining ring 42f is larger than the diameter of the insertion hole 42g, and is a diameter that can freely rotate in the outer cylinder 42a. The distance from the retaining ring 42f to the bolt head 42i is slightly longer than the plate thickness of the lid portion 42c. Thereby, the rotation in the circumferential direction of the bolt 42e with respect to the outer cylinder 42a is allowed and the movement in the axial direction is regulated, and the bolt 42e can be prevented from coming out of the outer cylinder 42a.

In the present embodiment, the retaining ring 42f is a nut with a screw groove formed on its inner periphery, and is screwed to the screw shaft 42h of the bolt 42e. An open window 42j opened to the building side (the right side in FIG. 14) is formed in a portion of the outer cylinder 42a immediately below the lid portion 42c. Thereby, the worker can insert the retaining ring 42f into the outer cylinder 42a from the open window 42j, and screw the retaining ring 42f to the outer periphery of the screw shaft 42h that has been inserted into the outer cylinder 42a from above the lid portion 42c. Then, the retaining ring 42f is moved to an arbitrary position in the axial direction of the screw shaft 42h, and the retaining ring 42f is welded to the screw shaft 42h.

Thus, by using a nut as the retaining ring 42f, the retaining ring 42f can be welded in a state where it is temporarily fixed at an arbitrary position of the screw shaft 42h of the bolt 42e, and therefore the retaining ring 42f can be easily fixed to the bolt 42e. However, the retaining ring 42f may be a simple ring having no screw groove on the inner periphery. Further, in place of the retaining ring 42f, a pin or the like may be inserted orthogonal to the screw shaft 42h of the bolt 42e to retain the bolt 42e; the configuration of the retaining member that prevents the bolt 42e from coming off from the outer cylinder 42a may be appropriately changed.

The nut 42d is screwed to the outer periphery of the screw shaft 42h inserted into the outer cylinder 42a, below the retaining ring. The upper end of the movable shaft 42b is welded to the lower end of the nut 42d, and the movable shaft 42b and the nut 42d move integrally. The outer peripheral shape of the nut 42d is a quadrangular prism, and each side surface is in sliding contact with the inner peripheral surface of the outer cylinder 42a in a quadrangular cylindrical shape. The outer diameter of the movable shaft 42b in a circular cylindrical shape is equal to the length of one side of the nut 42d (the distance between side surfaces facing each other), and four places in the circumferential direction of the movable shaft 42b are in sliding contact with the inner peripheral surface of the outer cylinder 42a. Thereby, the movable shaft 42b sliding in the outer cylinder 42a can be prevented from inclining in the outer cylinder 42a.

Both the inner peripheral shape of the outer cylinder 42a and the outer peripheral shape of the nut 42d in sliding contact with each other are non-perfect-circular shapes. Thus, the movable shaft 42b is prevented from rotating in the circumferential direction with respect to the outer cylinder 42a (is blocked from rotation) by the nut 42d.

As shown in FIG. 13 and FIG. 14, the movable shaft 42b is inserted into the outer cylinder 42a from the lower end opening of the outer cylinder 42a, and protrudes its lower end downward from the outer cylinder 42a. The insertion hole 41e formed in the fixed grasping piece 41b has a size allowing insertion of the movable shaft 42b, and the movable shaft 42b can be inserted into the outer cylinder 42a through the insertion hole 41e when fixing the operating unit 42 to the main body portion 41. Thereby, even when the axial length of the movable shaft 42b is longer than the gap between the support piece 41a and the fixed grasping piece 41b, the movable shaft 42b can be inserted into the outer cylinder 42a fixed to the support piece 41a. The movable grasping piece 44 is welded to the lower end of the movable shaft 42b protruding to the outside of the outer cylinder 42a.

In the case of the above configuration, when the bolt 42e is rotated in the tightening direction, the movable shaft 42b is fed out together with the nut 42d by a feed screw and goes out from the outer cylinder 42a, and the movable grasping piece 44 comes closer to the fixed grasping piece 41b. When the bolt 42e is rotated in the opposite direction, the movable shaft 42b is pulled back together with the nut 42d and enters the outer cylinder 42a, and the movable grasping piece 44 moves away from the fixed grasping piece 41b. In this way, in the present embodiment, the operating unit 42 can move the movable grasping piece 44 farther or closer with respect to the fixed grasping piece 41b by causing the movable shaft 42b to exit or enter the outer cylinder 42a by means of a feed screw mechanism.

Therefore, when the bolt 42e is rotated in the tightening direction in a state where the H-shaped steel beam 2 is placed between the movable grasping piece 44 and the fixed grasping piece 41b, the movable shaft 42b moves downward, and the H-shaped steel beam 2 is grasped by the movable grasping piece 44 and the fixed grasping piece 41b; thus, the fixing tool 40 can fix the vertical prop 4 to the H-shaped steel beam 2. When detaching the vertical prop 4 from the H-shaped steel beam 2, the bolt 42e may be rotated in the opposite direction.

Next, the movable grasping piece 44 is formed of one quadrangular sheet of stainless steel, and includes: a flat plate portion 44a joined to the lower end of the movable shaft 42b; and bent portions 44b bent downward from the left and right ends of the flat plate portion 44a.

Here, the movable grasping piece 44 may be formed in a bowl shape like the dish unit 32c shown in FIG. 2 and FIG. 3, but the length is increased in the case of a bowl shape. Therefore, when the wall thickness of the movable grasping piece 44 is increased in order to increase the bending strength of the movable grasping piece 44, the size of the fixing tool 40 is increased.

Thus, in order to suppress a size increase of the fixing tool 40 while increasing the bending strength of the movable grasping piece 44, the movable grasping piece 44 may be formed in a single flat plate shape. Thus, since the length of the movable grasping piece 44 in a flat plate shape is shorter than that of a movable grasping piece 44 in a bowl shape, a size increase of the fixing tool 40 can be prevented even when the wall thickness of the movable grasping piece 44 is increased in order to increase bending strength.

However, since the movable grasping piece 44 is coupled to the movable shaft 42b by welding, a convex portion may be generated on the abutment surface of the movable grasping piece 44 abutting the H-shaped steel beam 2 due to welding distortion. In this case, the movable grasping piece 44 abuts the H-shaped steel beam 2 at one place of the convex portion. Thus, when a rotational moment in the left direction or the right direction acts on the vertical prop 4, the fixing tool 40 may slide off from the H-shaped steel beam 2 because the movable grasping piece 44 abuts the H-shaped steel beam 2 only at one place of the convex portion.

In contrast, since the movable grasping piece 44 of the present embodiment includes bent portions 44b bent downward from the left and right ends of the flat plate portion 44a, the movable grasping piece 44 abuts the H-shaped steel beam 2 at least at two places. Therefore, as compared to the case where the movable grasping piece 44 is formed simply in a single flat plate shape, even when a rotational moment in the left direction or the right direction acts on the vertical prop 4, the fixing tool 40 can be prevented from slipping off from the H-shaped steel beam 2.

Furthermore, since the movable grasping piece 44 of the present embodiment is formed by bending and molding the left and right ends of the flat plate portion 44a in a single plate shape downward, the length of the movable grasping piece 44 is shorter than that in the case where the movable grasping piece 44 is formed in a bowl shape. Therefore, even when the wall thickness of the movable grasping piece 44 is increased, a size increase of the fixing tool 40 is prevented.

In the present embodiment, there is a case where the worker falls from the passage or the like and the weight of the worker acts on the handrail 6, consequently the handrail 6 experiences bending or the like, and a rotational moment in the left direction or the right direction in FIG. 12, which is the extending direction of the handrail 6, acts on the vertical prop 4. In this case, the fixing tool 40 tends to incline to the left or right together with the vertical prop 4, and bending force is applied to the movable grasping piece 44; however, in the present embodiment, since the wall thickness of the movable grasping piece 44 is increased to increase bending strength (rigidity), the movable grasping piece 44 is prevented from being greatly deformed by the load, and the inclination of the vertical prop 4 is suppressed.

When the worker falls from the passage or the like, not only a rotational moment in the left direction or the right direction but also a rotational moment in the rear direction acts on the vertical prop 4. When a rotational moment in the rear direction acts on the vertical prop 4, the load is concentrated on the rear side of the movable grasping piece 44, and therefore a force to bend the front side of the movable grasping piece 44 rearward acts on the movable grasping piece 44. In this regard, since the bent portions 44b of the movable grasping piece 44 of the present embodiment are formed by bending the left and right ends of the flat plate portion 44a, that is, a pair of side end portions of the flat plate portion 44a facing each other in the extending direction of the handrail 6 downward, the bending strength against the force to bend the front side of the movable grasping piece 44 when a rotational moment in the rear direction acts on the vertical prop 4 is particularly high. Therefore, in the case of the movable grasping piece 44 of the present embodiment, even when a rotational moment in the rear direction acts on the vertical prop 4, the movable grasping piece 44 is prevented from being greatly deformed, and the inclination of the vertical prop 4 is suppressed.

Thus, in the fixing tool 40 of the present embodiment, while a size increase of the fixing tool 40 is prevented, the inclination of the vertical prop 4 when a rotational moment acts on the vertical prop 4 can be suppressed, and even when a rotational moment in the left direction or the right direction acts on the vertical prop 4, the fixing tool 40 can be prevented from slipping off from the H-shaped steel beam 2.

As described above, in the handrail apparatus 10A of the present embodiment, the fixing tool 40 that fixes the vertical prop 4 to the H-shaped steel beam 2 as an attachment target member has: a main body portion 41 that has a support piece 41a and a fixed grasping piece 41b arranged facing each other with a predetermined gap and a coupling piece 41c coupling one end of the support piece 41a and one end of the fixed grasping piece 41b and to which the vertical prop 4 is fixed; a movable grasping piece 44 that is placed between the support piece 41a and the fixed grasping piece 41b and can grasp the attachment target member together with the fixed grasping piece 41b; and an operating unit 42 that has an outer cylinder 42a fixed to the support piece 41a and a movable shaft 42b that is inserted into the outer cylinder 42a in such a manner as to be movable in the axial direction while being blocked from rotation against the outer cylinder 42a and to the terminal end of which the movable grasping piece 44 is coupled, and that causes the movable shaft 42b to exit or enter the outer cylinder 42a to move the movable grasping piece 44 farther or closer with respect to the fixed grasping piece 41b; the movable grasping piece 44 has: a flat plate portion 44a in a single plate shape; and bent portions 44b formed by bending a pair of side end portions of the flat plate portion 44a facing each other in the extending direction of the handrail 6 toward the fixed grasping piece 41b.

In the case of this configuration, since the length of the movable grasping piece 44 is shorter than the length of a movable grasping piece 44 formed in a bowl shape, even when the plate thickness of the movable grasping piece 44 is increased to ensure strength, a size increase of the fixing tool 40 can be prevented. In the case of the handrail apparatus 10A of the present embodiment, since the plate thickness of the movable grasping piece 44 can be made sufficiently thick to increase the strength without increasing the size of the fixing tool 40, even when a large moment acts on the vertical prop 4, an event where the movable grasping piece 44 is greatly deformed and the inclination of the vertical prop 4 is increased can be prevented.

In addition, since the movable grasping piece 44 of the present embodiment has bent portions 44b formed by bending a pair of side end portions of the flat plate portion 44a facing each other in the extending direction of the handrail 6 toward the fixed grasping piece 41b, the movable grasping piece 44 has high bending strength against a force to bend the front side of the movable grasping piece 44 when a rotational moment in the rear direction acts on the vertical prop 4. Therefore, even when a rotational moment in the rear direction acts on the vertical prop 4, the movable grasping piece 44 is prevented from being greatly deformed, and the inclination of the vertical prop 4 is suppressed.

Furthermore, since the movable grasping piece 44 of the present embodiment has bent portions 44b formed by bending a pair of side end portions of the flat plate portion 44a, the movable grasping piece 44 abuts the H-shaped steel beam 2 at least at two places. Therefore, as compared to the case where the movable grasping piece 44 is formed simply in a single flat plate shape, even when a rotational moment in the right direction or the left direction as viewed from the building side acts on the handrail 6 on the vertical prop 4, the fixing tool 40 is prevented from slipping off from the H-shaped steel beam.

That is, in the case of the handrail apparatus 10A of the present embodiment, while a size increase of the fixing tool 40 is prevented, the inclination of the vertical prop 4 when a rotation moment acts on the vertical prop 4 can be suppressed, and even when a rotation moment in the left direction or the right direction acts on the vertical prop 4, the fixing tool 40 can be prevented from sliding off from the H-shaped steel beam 2.

The bent portions 44b may be formed by bending a pair of side end portions of the flat plate portion 44a facing each other in a direction orthogonal to the extending direction of the handrail 6. Even in this case, since the movable grasping piece 44 abuts the H-shaped steel beam 2 at two places, similar effects to those of the present embodiment are exhibited. However, in this case, when a rotational moment in the extending direction of the handrail 6 acts on the vertical prop 4 and bending force is applied to the movable grasping piece 44 because the fixing tool 40 tends to incline together with the vertical prop 4, each bent portion 44b is in contact with the H-shaped steel beam 2 at a point. In contrast, in the case where, as in the present embodiment, the bent portions 44b are formed by bending a pair of side end portions of the flat plate portion 44a facing each other in the extending direction of the handrail 6, when a rotational moment in the extending direction of the handrail 6 acts on the vertical prop 4 and bending force is applied to the movable grasping piece 44 because the fixing tool 40 tends to incline together with the vertical prop 4, each bent portion 44b is in contact with the H-shaped steel beam 2 in a line; therefore, the contact area is increased, and detachment from the H-shaped steel beam 2 is less likely to occur.

Although ribs may be welded to the abutment surface of the flat plate portion 44a in order to increase the number of places abutting the H-shaped steel beam 2, when a rotational moment in the extending direction of the handrail 6 acts on the vertical prop 4 and bending force is applied to the movable grasping piece 44, the force is concentrated on the ribs, and therefore the ribs may be detached from the flat plate portion 44a. In contrast, since the bent portions 44b of the present embodiment are integrally molded with the flat plate portion 44a, there is no such concern.

Furthermore, in the present embodiment, the movable grasping piece 44 is formed of stainless steel, and has high strength against bending. Therefore, even when bending force acts on the movable grasping piece 44, the movable grasping piece 44 can be prevented from being damaged. However, the material of the movable grasping piece 44 is not limited to stainless steel and may be appropriately changed as long as strength against bending of the movable grasping piece 44 is ensured.

Hereinabove, preferred embodiments of the present invention are described in detail; however, it goes without saying that alterations, modifications, and changes can be made without departing from the scope of claims. The present application claims priority based on Japanese Patent Application No. 2020-038586 filed with the Japanese Patent Office on Mar. 6, 2020, and the entire contents of this application are incorporated into the present specification by reference.

### REFERENCE SIGNS LIST

1 slider device
2 H-shaped steel beam (attachment target member)
3, 40 fixing tool
4 vertical prop
5A, 5B handrail holding member
6 handrail
6a bar member
6b insertion hole
7 slider main body
9, 9A, 9B handrail coupling member
10, 10A handrail apparatus
11 cylindrical body
11a opening hole
12 pin rod (stop pin)
13 coil spring (spring member)
17 torsion coil spring (spring member)
18 first pin member (stop pin)
20 leaf spring (spring member)
21 second pin member (stop pin)
29 coil spring (biasing member)
41 main body portion
41a support piece
41b fixed grasping piece
41c coupling piece
42 operating unit
42a outer cylinder
42b movable shaft
44 movable grasping piece
44a flat plate portion
44b bent portion
51 socket
52 wedge
52f long hole
53 bolt shaft
54 coil spring
55 spacer
56 nut
A retaining mechanism
R1 fixed roller
R2 movable roller

1. A slider device
that is mounted in such a manner as to be freely movable along an extending direction of a handrail and can hold a lifeline,
the slider device comprising:
a slider main body that can move in the extending direction of the handrail while holding the handrail; and
a plurality of pairs of rollers that are provided on the slider main body in a plurality of places apart from each other in the extending direction of the handrail, grasp side surfaces of the handrail, and can travel on the side surfaces of the handrail,
wherein one of the rollers facing each other across the handrail is a fixed roller fixed to the slider main body and
another of the rollers facing each other across the handrail is a movable roller supported in such a manner as to be able to get farther or closer with respect to the handrail, and
each of the movable rollers is biased toward the handrail by a biasing member.

2. A handrail apparatus comprising:
a plurality of vertical props attached to an attachment target member and standing;
a handrail holding member provided on each of the vertical props;
a handrail held by the handrail holding members and stretched between adjacent ones of the vertical props; and
the slider device according to claim 1, the slider device being mounted in such a manner as to be freely movable along the extending direction of the handrail.

3. The handrail apparatus according to claim 2, wherein
the handrail holding member has:
a socket that is coupled to the vertical prop and into which the handrail can be inserted;
a wedge that is inserted into the socket and can grasp the handrail together with the socket; and
a retaining mechanism coupling the wedge to the socket in a freely slidable manner and pressing the wedge against the socket, and
the retaining mechanism has:
a long hole formed in the wedge along an insertion direction of the wedge;
a bolt shaft protruding inward from the socket and inserted into the long hole;
a coil spring mounted on an outer periphery of the bolt shaft; and
a nut screwed to an end portion of the bolt shaft and applying a compressive load to the coil spring.

4. The handrail apparatus according to claim 3, comprising
a spacer in a cylindrical shape that is mounted between the outer periphery of the bolt shaft and an inside of the coil spring and regulates movement in a tightening direction of the nut.

5. The handrail apparatus according to claim 2, wherein
the handrail has: a plurality of bar members held by the handrail holding members and each provided with insertion holes in both end portions; and a handrail coupling member coupling end portions facing each other of adjacent ones of the bar members, and
the handrail coupling member has: a cylindrical body into which the bar member can be inserted; a pair of opening holes provided in the cylindrical body along an axial direction; stop pins inserted into the opening holes in such a manner as to freely exit or enter; and spring members biasing the stop pins in insertion directions, and couples end portions of adjacent ones of the bar members by a process in which the end portions of the adjacent bar members are inserted into the cylindrical body from both sides and the stop pins are inserted into the insertion holes of the bar members and the opening holes of the cylindrical body in a state where the insertion holes and the opening holes are made to face each other.

6. The handrail apparatus according to claim 2,
comprising a fixing tool that fixes the vertical prop to the attachment target member,
wherein the fixing tool has:
a main body portion that has a support piece and a fixed grasping piece arranged facing each other with a predetermined gap and a coupling piece coupling one end of the support piece and one end of the fixed grasping piece and to which the vertical prop is fixed;
a movable grasping piece that is placed between the support piece and the fixed grasping piece and can grasp the attachment target member together with the fixed grasping piece; and
an operating unit that has an outer cylinder fixed to the support piece and a movable shaft that is inserted into the outer cylinder in such a manner as to be movable in an axial direction while being blocked from rotation against the outer cylinder and to a terminal end of which the movable grasping piece is coupled, and that causes the movable shaft to exit or enter the outer cylinder to move the movable grasping piece farther or closer with respect to the fixed grasping piece, and
the movable grasping piece has: a flat plate portion in a single plate shape joined to the terminal end of the movable shaft; and bent portions formed by bending a pair of side end portions of the flat plate portion facing each other in the extending direction of the handrail toward the fixed grasping piece.
